(19) United States
(12) Patent Application Publication
(10) Pub. No.: US 2026/0008022 A1
(43) Pub. Date: Jan. 8, 2026

(54) Heating Elements of a Heater Controlled by a Frequency Converter for Heating a Substance or Substance Mixture in a Device

(71) Applicant: Enespa Technologies AG, Appenzell (CH)

(72) Inventor: Robin Schroer, Appenzell (CH)

(21) Appl. No.: 19/249,519

(22) Filed: Jun. 25, 2025

(30) Foreign Application Priority Data
Jun. 26, 2024 (DE) 102024118134.6

(51) Int. Cl. B01J 6/00; C10B 53/07; H05B 1/02; H05B 3/40

(52) U.S. Cl. CPC B01J 6/008; C10B 53/07; H05B 1/0247; H05B 3/40; H05B 2203/005; H05B 2203/007; H05B 2203/035

(57) ABSTRACT

In order to improve a device for heating a substance or substance mixture, wherein the device has a heater with at least one heating element and at least one control device for controlling the at least one heating element, in such a way that the temperature can be set as precisely as possible even in high temperature ranges, it is proposed that the at least one control device has or consists of a frequency converter.

This application claims the benefit of priority to German Patent No. 10 2024 118 134.6 filed Jun. 26, 2024, which is incorporated by reference in its entirety herein.

### FIELD OF THE INVENTION

The invention relates to a device for heating a substance or substance mixture, wherein the device has a heater with at least one heating element and at least one control device for controlling the at least one heating element.

Furthermore, the invention relates to a plastics pyrolysis plant with at least one device for heating a substance or substance mixture.

Ferner the invention relates to a method for controlling a heating element of a heater for a device for heating a substance or substance mixture.

Furthermore, the invention relates to the use of a frequency converter for controlling a heating element of a heater for a device for heating a substance or substance mixture.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

EP 0297424 B1 describes a method for cooling hot pyrolysis gas, which incurs during the pyrolysis of waste material containing plastic, rubber or other hydrocarbons, wherein the pyrolysis oil obtained is cooled in direct heat exchange in at least two cooling stages through which the pyrolysis gas flows in succession.

Thus, there remains a need for systems and methods to improve delivery of antibodies, immunoglobulin receptors, or other immune agents or immunologics across the BBB without damaging the BBB.

### SUMMARY OF THE INVENTION

The object of the present invention is to improve a device for heating a substance or substance mixture, wherein the device has a heater with at least one heating element and at least one control device for controlling the at least one heating element, in such a way that a most precise possible temperature control of the substance or substance mixture within the device can be achieved even at very high temperatures while avoiding large temperature fluctuations.

According to the invention, a device for heating a substance or substance mixture is proposed for this purpose, wherein the device has a heater with at least one heating element and at least one control device for controlling the at least one heating element, wherein according to the invention the at least one control device has or consists of a frequency converter.

The device for heating a substance or substance mixture can have any suitable shape and is essentially a container for receiving the substance or substance mixture. The substance or substance mixture can be introduced into the container for heating and/or passed or conveyed through the container for heating.

The device can be part of a plant, for example a water heating plant, a die casting machine or a plastics melting plant. In particular, the device is part of a plastics pyrolysis plant.

The substance or substance mixture can be a solid, a liquid or in a gaseous state. Preferably, the substance or substance mixture is fed to the device in a solid state and heated within the device in such a way that the substance or substance mixture changes to a liquid or also gaseous state.

According to the invention, for controlling the at least one heating element, a frequency converter is used which supplies the heating element with the set voltage. Depending on the desired set temperature, the output voltage of the frequency converter is varied accordingly.

In principle, electrical components can be used for controlling heating elements for such devices in order to control the heating elements in the corresponding temperature ranges. For example, simple electrical switching elements, such as solid-state relays, are used for this purpose. In a further development step, PID controllers or thyristor controllers were used, which can be controlled analogously. In all cases, however, it has been shown that the temperature deviations or the resulting tolerances are unreasonably high for many applications, especially at high temperatures, for example in the range of over 350° C.

The aforementioned electrical components for controlling the heating elements usually have to be set to a relatively high voltage range during the heating phase so that they switch through at all. However, this means that the temperatures quickly exceed the desired temperature in the heating range or that precise controlling or setting of the temperature takes a long time, often several hours. Such control components are an inadequate basis, particularly for applications in which the temperatures must be set to the exact degree, i.e. with only very small fluctuations and tolerances. During the heating process, the temperatures often overshoot and have to be adjusted up and down over a long period of time until the desired temperature is set exactly. This also leads to unnecessarily high power consumption.

Surprisingly, it has been found that controlling a heating element of a heater by means of a frequency converter can be accomplished much more precisely and overcomes the aforementioned disadvantages.

Heating elements essentially represent an ohmic resistor, wherein heat is generated by means of current flow.

Frequency converters, on the other hand, are usually used for controlling electric motors. From the frequency inverter's point of view, the consumer is not a heating resistor, but an electric motor, wherein the rotor generates the rotation.

In order to make the temperature control even more precise, the frequency converter is parameterized and set accordingly in accordance with the present invention. For example, by means of a software module it can be achieved that output voltages in steps of 0.1 volts are generated, which then serve for a very precise controlling of the heating element. This can ensure that there are no more temperature overshoots and that the temperature can be controlled to an accuracy of +/−0.1° C. Only very low voltages, e.g. in the range of 1 volt to 5 volts, are then required to maintain a desired temperature. Temperature overshoots can also be completely avoided during heating, which means that the heating time can be reduced to a third or a quarter.

A further advantage of controlling the heating element with a frequency converter is that at least 50% energy can be achieved compared to conventional control with the same heating elements due to the shorter heating time, the more precise temperature setting and the precise maintenance of a set temperature with very low constant output voltages.

Preferably, the device is formed elongated, particularly preferably tubular. The device can be arranged vertically, horizontally or at an angle in a plant.

Preferably, the device has an inlet for introducing the substance or substance mixture and an outlet for removing the heated substance or substance mixture. Since the substance or substance mixture can be chemically modified by heating the substance or substance mixture, the outlet also serves for removing a result produced by heating inside the device. For the purposes of the invention, removal is also to be understood as a transfer of the heated substance or substance mixture from the device to another device.

The inlet and/or outlet can be closable openings, valves or the like. The inlet and outlet are preferably arranged on opposite sides of the device. This allows the substance or substance mixture to be heated continuously on its way from the inlet to the outlet.

It is also preferably provided that the device has a conveying device in its interior for conveying or passing through the substance or substance mixture. The conveying device can be formed as a screw conveyor, for example. The conveying device serves for conveying the substance or substance mixture from the inlet to the outlet. It therefore conveys the material to be conveyed from the inlet to the outlet along a predetermined conveying axis. The material to be conveyed, i.e. the substance or substance mixture, is guided along the inner wall of the device in order to generate a heat input in this area by the heating elements arranged on the outer wall.

For this purpose, the at least one heating element is preferably arranged on an outer wall of the device.

The heater preferably has several individually controllable or individually controlled heating elements. The temperatures can be set individually and differently in sections inside the device. For example, each individual heating element can be set to a different target temperature. Preferably, several control devices with frequency adjusters are also provided for the individual control of each heating element.

The heating elements are preferably arranged one behind the other and/or next to each other along the outer wall of the device. In the case of an elongated or tubular device, the heating elements are preferably arranged around the tube and one behind the other.

By providing a large number of heating elements along the conveying direction from the inlet to the outlet, an increasing target temperature can be set and the substance or substance mixture can be heated continuously as it is conveyed through the device.

It is also preferably provided that the heater has temperature sensors for measuring an actual temperature of the substance and/or the substance mixture, wherein the temperature sensors project into an interior of the device and are electrically and/or communicatively coupled to the at least one control device. The actual temperature is measured at various points inside the device by means of the temperature sensors. The measured actual temperature then serves as an input signal for the control device to regulate the desired target temperature in this section inside the device. For this purpose, the voltage for the corresponding heating element is adjusted by means of the frequency converter.

Furthermore, it is preferable that the device is completely sleeved by the heating elements.

The at least one heating element is preferably formed as a heating sleeve. For example, the heating element can be formed as a multiphase, in particular 3-phase heating sleeve. The three phases of the heating element are then connected to the outputs U1, V1 and W1 of the frequency converter, for example.

According to the invention, there is also provided a plastics pyrolysis plant with at least one device described above for heating a substance or substance mixture. The at least one device described above is formed as a reactor tube for the thermochemical decomposition of organic compounds by targeted application of heat with the complete exclusion of oxygen.

The plastic pyrolysis plant is used for the thermochemical decomposition of organic compounds by targeted application of heat at temperatures of over 350° C. This leads to a breaking of bonds within large molecules with the complete exclusion of oxygen. The main function is to process plastic waste containing PE and PP in order to primarily obtain pyrolysis oil and gas.

The plastic pyrolysis plant is therefore a process engineering plant for processing plastic residues (polyolefins) for recovering valuable materials such as high-quality oils, gases, diesel and carbon. Possible materials or material mixtures therefore include LDPE, HDPE, LLDPE, PP, PP+C and/or PE.

The plastic pyrolysis plant works on the basis of thermochemical decomposition of organic compounds at temperatures of over 350° C. For example, the substance or substance mixture inside the reactor tube is heated to a temperature range between 400° C. and 600° C. by means of the heater described above. This process differs from gasification and combustion, as it takes place exclusively through heat and in the absence of oxygen. Gases, liquids and solids are produced, wherein the proportions and composition depend not only on the individual material, but also on the process temperature, the auxiliary materials added, the pressure ratios and the duration of treatment.

The input material is fed into the reactor tube via an inlet nozzle or the inlet. In the reactor tube, the material is transported via a conveyor system and mixed in order to ensure the best possible heat transfer. The outer wall of the reactor tube is heated by heating elements in the form of electric heating sleeves. The pyrolysis process begins inside the reactor tube when specific temperature limits are reached. This breaks down molecular bonds in the material and produces short-chain molecules.

Preferably, the plastic pyrolysis plant has several devices connected in series as described above. Following the first reactor tube, the material is then conveyed into a second reactor tube. Inside the second reactor tube, which is constructed in the same way as the first reactor tube and thus the device described above, the material or material mixture is also transported and mixed via a conveying device. Pyrolysis gas produced after heating leaves the respective reactor tube via a riser tube. Any remaining solids from the pyrolysis process are collected at the end of the second reactor tube via a solids discharge.

The pyrolysis gas is then liquefied in condensation steps in a high-temperature condenser and a low-temperature condenser. Cooling is realized via an indirect circuit. The condensed oil fractions from the two condensation steps can then be automatically conveyed to corresponding storage tanks. Non-condensable components of the pyrolysis gas are cleaned with water within the system.

According to the invention, there is also provided a method for controlling a heating element of a heater for a device described above, wherein the heating element is controlled by means of a control device and the control device has or consists of a frequency converter. An electrical voltage is set by means of the frequency converter and applied to the heating element.

The control device also has a software module which generates an output voltage at the frequency converter in as few voltage steps as possible, for example in 0.1 volt steps, by means of which the heating element can be precisely controlled. A temperature overshoot can thus be avoided, particularly during the heating phase, and the desired final temperature can be set precisely and in a very short time.

Preferably, by means of the frequency converter the electrical resistance of a winding of the heating element is continuously measured. A failure of the heating element can thus be detected at an early stage. In the case of heating elements with several windings, it can also be detected if the resistances of the individual windings change in such a way that they deviate from each other. This also indicates that the heating element is about to fail. By using a frequency converter for controlling the heating elements, there is no need for additional measuring devices. The frequency converter can be used to continuously measure and monitor the resistance of the heating element winding at the same time.

According to the invention, the use of a frequency converter for controlling a heating element of a heater for a device described above is also provided.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The invention is explained below by way of example using preferred embodiments. The figures show schematically:

FIG. 1 depicts a perspective view of a device for heating a substance or substance mixture.

FIG. 2 depicts a perspective view of a section of a device for heating a substance or substance mixture.

FIG. 3 depicts a simplified illustration of the components of a plastics pyrolysis plant.

### LIST OF REFERENCE SYMBOLS

100 Device for heating a substance or substance mixture;
200 Plastic pyrolysis plant;
10 Heater;
11 Heating element;
12 Control device;
13 Frequency converter;
14 Inlet;
15 Outlet;
16 Conveyor device;
17 Temperature sensor;
18 Software module;
20 Valve;
21 Solids discharge; and
22 Condenser.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

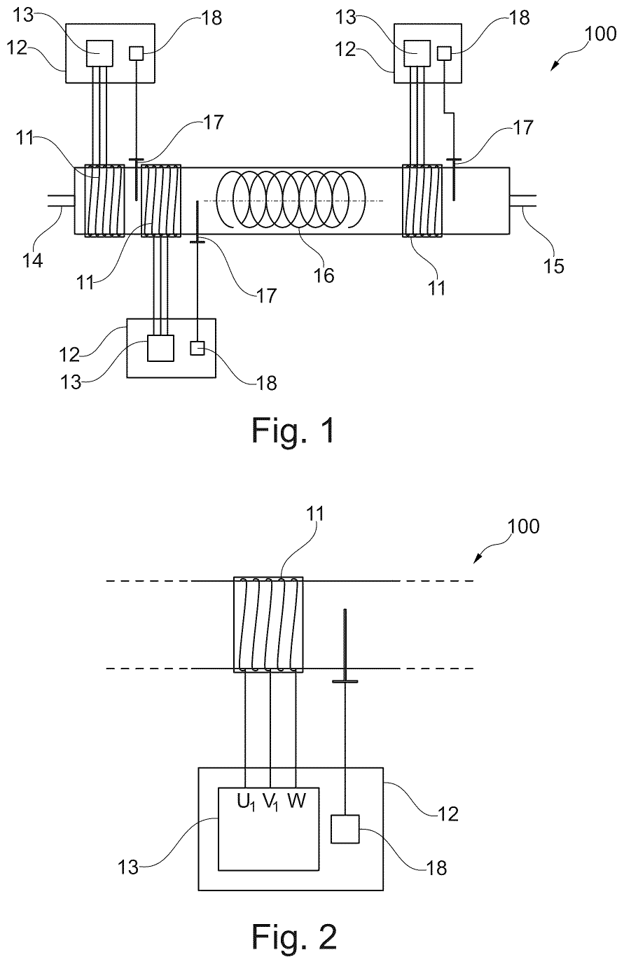

FIG. 1 shows a schematic illustration of a device 100 for heating a substance or substance mixture. The device 100 is tubular in the form of a reactor tube for a plastic pyrolysis plant 200 (not shown in FIG. 1 for the sake of clarity). The device 100 has a conveying device 16 in its interior for conveying a substance or substance mixture to be heated. The conveying device 16 is configured in the form of a screw conveyor and is shown in FIG. 1 only in principle in the center of the device 100.

The device 100 has an inlet 14 and an outlet 15. By means of the conveying device 16, the substance or substance mixture supplied at the inlet is conveyed longitudinally through the device 100 to the outlet 15.

The substance or substance mixture passing through the device 100 is continuously heated by means of several heaters 10. Each individual heater 10 has a separate heating element 11 and a control device 12. The control device 12 has a software module 18, which detects an actual temperature determined by a temperature sensor 17 in a section of the interior of the device 100 and controls the frequency converter 13 of the control device 12 accordingly. By means of the frequency converter 13 a precise output voltage is then applied to the heating element 11 in order to regulate the temperature in this section of the interior of the device 100 as precisely as possible.

The heating element 11 is arranged as a heating sleeve and completely surrounds the tubular formed device 100. For the sake of clarity, only three heaters 10, each with a heating element 11, are illustrated in FIG. 1.

Preferably, the heating elements 11 are arranged in the longitudinal direction of the tubular device 100 in such a way that they heat the outer wall of the device 100 directly adjacent to each other one behind the other in the longitudinal direction along the device 100. The target temperature can be controlled to rise continuously from the inlet 14 to the outlet 15.

For a better overview, FIG. 2 shows a section of the device 100 shown in FIG. 1, wherein only a section of the device 100 with a heater 10 and a heating element 11 is illustrated in this section. The heating element 11 is formed as a three-phase alternating current heater in the form of a heating sleeve and is arranged around the entire circumference of the tubular formed device 100. The three-phase heating sleeve is supplied with voltage via the three output voltages U1, V1 and W1 of the frequency converter 13.

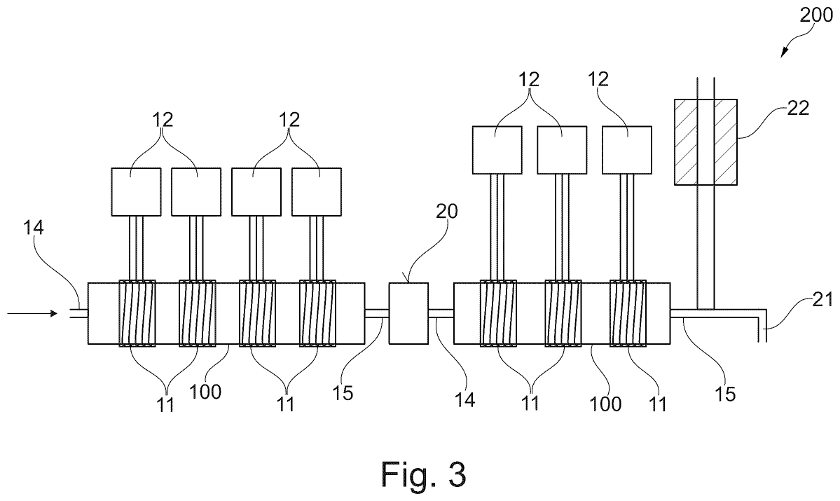

In FIG. 3 a section of a plastics pyrolysis plant 200 is illustrated in a very simplified manner. In FIG. 3, only the components of the plastics pyrolysis plant 200 that are essential for the invention are illustrated.

As an example, FIG. 3 shows two devices 100 connected in series for heating a substance or substance mixture. A valve 20 is arranged between the two devices 100. The substance or substance mixture is fed to the inlet 14 of the first device 100. Inside the first device 100, the substance or substance mixture is fed through in the longitudinal direction by means of a conveyor device 16, not illustrated in FIG. 3, and is continuously heated by means of the heating elements 11 arranged on the outer wall. The same occurs in the second device 100 arranged downstream. After passing through the second device 100, the pyrolysis gas produced is fed to a condenser 22. The remaining solids are collected via a solids discharge 21.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A device for heating a substance or substance mixture, comprising:
a heater with at least one heating element and at least one control device for controlling the at least one heating element, wherein the at least one control device comprises a frequency converter.

2. The device of claim 1, wherein the device has an elongated, tubular shape.

3. The device of claim 1, further comprising:
an inlet on the device for introducing the substance or substance mixture; and
an outlet on the device for configured to (i) remove the heated substance or substance mixture or (ii) remove a result produced by heating inside the device.

4. The device of claim 1, further comprising:
a conveying device in an interior of the device for passing the substance or substance mixture through the device.

5. The device of claim 1, wherein the at least one heating element is arranged on an outer wall of the device.

6. The device of claim 1, wherein the heater comprises a plurality of individually controllable heating elements.

7. The device of claim 6, wherein the plurality of heating elements are arranged linearly along an outer wall of the device.

8. The device of claim 1, wherein the heater comprises a plurality of temperature sensors configured to measure an actual temperature of the substance or substance mixture, wherein the plurality of temperature sensors project into an interior of the device and are electrically or communicatively coupled to the at least one control device.

9. The device of claim 7, wherein the device is sleeved by the heating elements.

10. The device of claim 1, the at least one heating element is formed as a heating sleeve.

11. A plastics pyrolysis system with at least one device of claim 1 configured to heat a substance or substance mixture, wherein the at least one device is formed as a reactor tube for the thermochemical decomposition of organic compounds by the targeted effect of heat with the complete exclusion of oxygen.

12. The plastics pyrolysis system of claim 11, further comprising a plurality of devices connected in series.

13. A method for controlling the at least one heating element of the heater of the device of claim 1, comprising the frequency converter of the control device sets and applies an electrical voltage to the heating element.

14. The method of claim 13, further comprising continuously using the frequency converter to measure an electrical resistance of a winding of the heating element.

15. A method using the device of claim 1, comprising using the frequency converter to control the heating element of the heater for the device.
